(19) United States
(12) Patent Application Publication
(10) Pub. No.: US 2008/0190204 A1
(43) Pub. Date: Aug. 14, 2008

(54) Variable-Capacity Capacitor Having A Specific Shape, Gyrometer Comprising One Such Capacitor And Accelerometer Comprising One Such Capacitor

(75) Inventors: Jean-Sebastien Danel, Echirolles (FR); Bernard Diem, Echirolles (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT AL'ENERGIE ATOMIQUE, Paris (FR)

(21) Appl. No.: 11/815,409

(22) PCT Filed: Feb. 1, 2006
(86) PCT No.: PCT/FR06/50084

§ 371 Date: Aug. 2, 2007

(30) Foreign Application Priority Data
Feb. 3, 2005 (FR) 0550312

(51) Int. Cl. G01P 3/44; H01G 5/01

(52) U.S. Cl. 73/514.32; 361/278; 73/504.12; 73/488

(57) ABSTRACT

A variable capacitor including at least two interdigitized combs provided with teeth, the cross section of the end of a tooth adjacent to the other comb being greater than the cross section of the end of a tooth remote from the other comb. The variable capacitor can be used in gyrometers and accelerometers.

### TECHNICAL DOMAIN AND PRIOR ART

This invention is related mainly to a capacitor with variable capacitance (variable capacitor) used particularly in miniature gyrometers and accelerometers. The surface area of these devices is less than 1 cm² and they are used particularly in the automobile field, particularly to increase passenger safety. For example, these devices provide information to trigger airbag during shocks when a deceleration greater than a predetermined value is detected, or when the vehicle does a roll-over, and to provide driving assistance when skids occur. These devices are also used in the aeronautical and medical field, and in manufacturing of medical instruments.

Variable capacitors used in micro-technology comprise two interdigitised capacitive combs, one being fixed and the other being mobile, operating either in a so-called air gap variation mode, or in a so-called area variation mode.

Each comb comprises teeth inserted with a clearance between the teeth of the other comb. The teeth on each comb are rectangular in shape and are inserted between two teeth of the other comb that also form a rectangular shaped space. The distance separating two directly adjacent teeth is called the air gap. Operation in air gap variation consists of measuring the variation of the air gap when the mobile comb moves with respect to the fixed comb in a direction perpendicular to the teeth.

Operation in area variation consists of measuring the change in the facing surface area of a tooth on the fixed comb and a tooth on the mobile comb when one of the combs moves along the axis of the tooth.

It appears that so-called area variation operation is more suitable in the case in which it is required to make an actuator to produce large displacements or a capacitance meter capable of measuring large displacements, because the possible displacement of the mobile comb with respect to the fixed comb is not limited by the dimension of the air gap (which must preferably remain small). This is not the case for so-called air gap variation operation.

It is then required to make variable capacitors with a small air gap, for example between 1.5 μm and 2 μm, and a large displacement along the axis of the teeth, for example between 5 μm and 10 μm. The fact that it is required to make variable capacitors with a small air gap and a large movement along the axis of the teeth causes manufacturing problems.

Firstly, it is desirable to have a relatively uniform capacitor geometry so as to have greater uniformity of etchings, particularly in the case of etching by anisotropic plasma. It is slower to etch a fine pattern than to etch a larger pattern. Thus, there may be some non-uniformity in the etching if the values of the air gap and the movement distance are very different.

Secondly, existing technologies require the creation of an interconnection level between different parts of the capacitor: this is done by depositing a sacrificial layer on the etched structures, that must completely cover the combs and therefore in particular fill in the spaces between the combs. The interconnection structures are then made and the sacrificial layer is etched so as to separate the required interconnection bridges from the comb surfaces. But it is very difficult to fill in large air gaps correctly.

Therefore another purpose of this invention is to provide a variable capacitor capable of making large displacements.

Another purpose of this invention is to provide a variable capacitor that can be manufactured reliably.

### PRESENTATION OF THE INVENTION

These purposes are achieved by a variable capacitor operating by surface variation comprising at least a first and a second comb provided with interdigitised teeth in which the cross section of the ends of the teeth of each comb oriented towards the other comb is smaller than the cross section of the end of the connection to the comb body.

In other words, the air gap zone is made a s large as possible and the zone along the axis of the teeth is made as small as possible, it results that the value of this movement relative to the value of the air gap at the end of the comb measured along the axis of the comb body can be increased, while reducing the proportion of the large zone that can seriously compromise the uniformity of etching, and causing a problem for filling it in using the sacrificial layer.

The main object of this invention is then a variable capacitor comprising at least a first and a second interdigitised electrode formed by combs, each provided with a body along a main axis and teeth along secondary axes, said teeth being parallel to each other and capable of a movement along their secondary axis, the teeth comprising first ends through which they are connected to the body and free second ends opposite to the first ends facing the other comb, in which the cross section of the second free end of the teeth is smaller than the cross section of the first end connected to the comb.

Advantageously, the pairs of teeth define spaces with a shape complementary to the shape of the teeth in the other comb.

In one embodiment, the free end of the teeth is formed by at least two segments.

In the first example embodiment, the free ends are shaped in a point.

In the second embodiment, the free ends of the teeth are shaped like a trapezium, the large base of the trapezium being oriented to the tooth.

In a third example embodiment, the free ends of the teeth are formed by non-intersecting first and second segments with identical lengths and symmetrical about a longitudinal axis of the tooth and being connected by an infinite number of segments forming an arc of a circle.

Advantageously, the air gap separating a transverse end of a tooth of a comb from a transverse end of a directly adjacent tooth of another comb is between 1 μm and 3 μm.

The distance separating the free end of a tooth of a comb from the other comb along an axial direction of the tooth is advantageously between 3 μm and 15 μm.

In one embodiment, the combs are made of silicon.

In another embodiment, the combs are made of an electrically insulating material covered with an electrically conducting material.

Advantageously, said combs are made of quartz or silica.

Another purpose of this invention is a gyrometer comprising a variable capacitor according to this invention.

Another purpose of this invention is an accelerometer comprising a variable capacitor according to this invention.

Another purpose of this invention is a process of manufacturing the variable capacitor according to this invention comprising a mobile electrode and a fixed electrode, using a substrate, this process also comprising steps of:
etching the substrate to form electrode teeth, the teeth being separated by trenches, the teeth having a variable cross section;
forming electrode connection means.

In particular, the formation of connection means also comprises steps of:
depositing and structure a sacrificial layer, preferably made from PSG;
making interconnections, advantageously from poly-silicon;
making interconnections on the sacrificial layer between the electrodes and the zones to be electrically connected;
etching the substrate and the sacrificial layer so as to release the mobile electrode.

Advantageously, the substrate comprises a silicon-base layer covered on one face by a silicon oxide layer, itself covered by a silicon layer.

SiN insulation patterns may also be made before the sacrificial layer is deposited.

Advantageously, the mobile electrode is released from the substrate by etching the silicon oxide layer.

This invention will be better understood after reading the following description and the appended drawings.

### BRIEF DESCRIPTION OF THE DRAWINGS

FIG. 1 shows a perspective partial view of a variable capacitor according to prior art;

FIG. 2 shows a diagrammatic top view of the first preferred example of a capacitor according to this invention;

FIG. 3 shows a diagrammatic top view of a second example embodiment of a capacitor according to this invention;

FIG. 4 shows a diagrammatic top view of a third example embodiment of a capacitor according to this invention;

FIG. 5 shows a table illustrating the variation of the value of the axial movement of the teeth as a function of the value of the angle of the teeth;

FIGS. 6a to 6d represent steps in manufacturing a capacitor according to this invention.

### DETAILED PRESENTATION OF PARTICULAR EMBODIMENTS

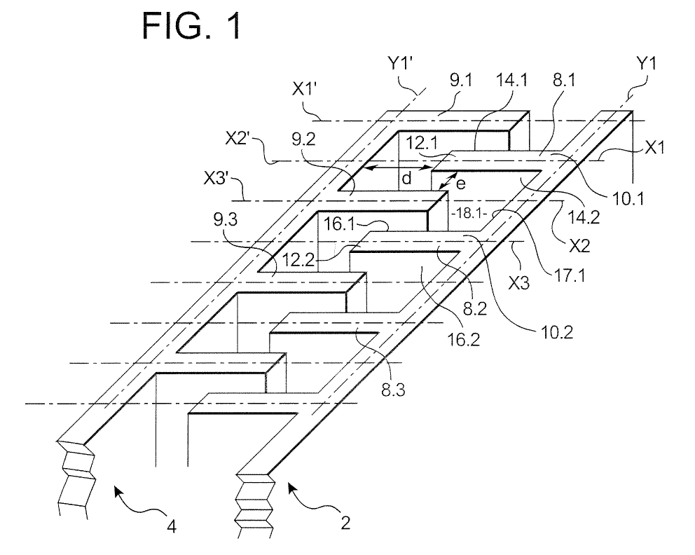

FIG. 1 shows a variable capacitor according to the state of the art, for example used in miniaturized gyrometers and accelerometers. The capacitor comprises a first interdigitised comb 2 and a second interdigitised comb 4. The first comb 2 comprises a body 6 with a longitudinal axis Y1 and several teeth 8.1, 8.2, 8.3 . . . , 8.n (where n is the number of teeth) with axis X1, X2, X3 . . . , Xn respectively, orthogonal to the axis Y1 of the body 6. The second comb 4 comprises a body 7 with a longitudinal axis Y1′ and several teeth 9.1, 9.2, 9.3, . . . 9.n with axes X1′, X2′, X3′, . . . Xn′ respectively. The two combs have approximately the same structure and all teeth are identical, thus detailed description will be limited to two adjacent teeth. Teeth 8.1 and 8.2 comprise a first axial end 10.1, 10.2 through which they are connected to the body 6, and a second free axial end 12.1, 12.2 that will face the body of the other comb. Each tooth is approximately rectangular in shape, formed transversely by two approximately parallel sides 14.1, 14.2, and 16.1, 16.2; the second axial end 12.1, 12.2 is formed by a segment connecting the first and the second sides 14.1, 14.2, and 16.1, 16.2 respectively and parallel to the Y1 axis.

Each tooth is connected to the next tooth through a flat bottom 17.1 parallel to the axis Y1 and each pair of teeth forms an approximately rectangular shaped space 18.1 inside which one tooth of the other comb can be inserted.

The directly adjacent sides 16.1 and 14.2 of two teeth are separated by a distance e called the air gap. The free end 12.1, 12.2, of each tooth is separated from the other comb along the axis of the tooth by a distance d.

It is desirable to have a thin air gap e and a large distance d. Etching such capacitors is a complex operation due to the non-uniformity of their structure and it is impossible to obtain reliable and complete filling of spaces between combs by a sacrificial layer like that described above.

This invention solves these problems.

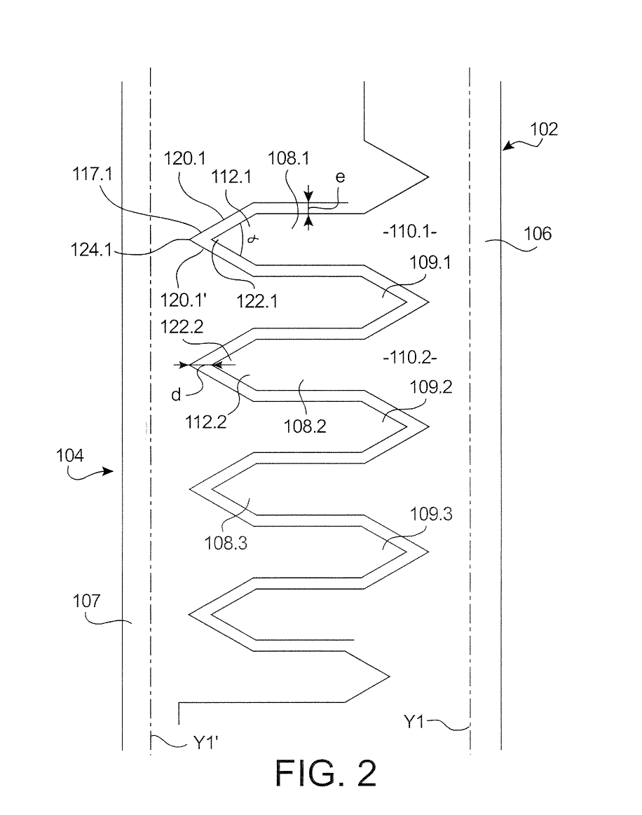

FIG. 2 shows a first example embodiment of a variable capacitor according to this invention comprising a first comb 102 and a second comb 104. The first comb 102 comprises a body 106 with axis Y1 and teeth 108.1, 108.2, 108.3 . . . with axes X1, X2, X3 . . . orthogonal to axis Y1. The second comb comprises a body 107 with axis Y1′ and teeth 109.1, 109.2, 109.3 . . . with axes X1′, X2′, X3′ . . . . As for the capacitors according to prior art, the detailed description will be limited to the two teeth in the first comb 2. The teeth 108.1 and 108.2 are connected to the body 106 through first longitudinal ends 110.1, 110.2 respectively, and also comprise second free longitudinal ends 112.1, 112.2 oriented towards the other comb. According to this invention, the free ends 112.1, 112.2 of the teeth 108.1, 108.2 have a cross section smaller than the cross section of the first ends 110.1, 110.2. In the example shown, the free ends 112.1, 112.2 are point shaped 122.1, 122.2 and are formed by an isosceles triangle, the base of the triangle being oriented to the body 106.

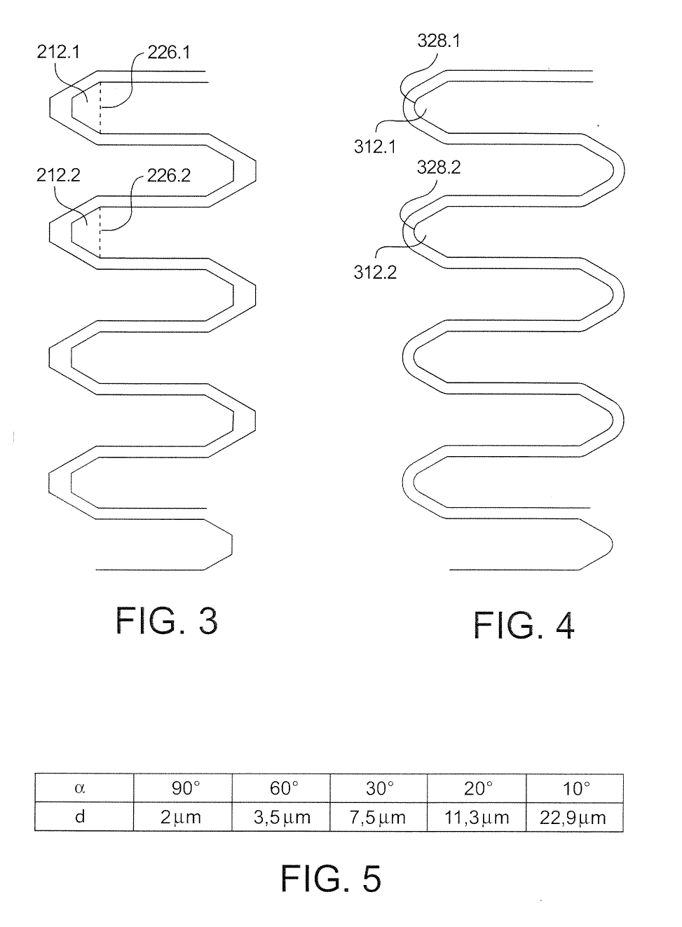

As can be seen in FIG. 1, the teeth 108.1, 108.2 comprise a first part connected to the body of the comb 106 with an approximately constant cross section, for example rectangular in shape. The second free end 112.1, 112.2 has a cross section smaller than the cross section of the first part, this section reducing progressively as the distance from the first end of the tooth increases. Thus, the second free end may be in the shape of a point as shown in FIG. 2, but it may also be trapezoidal in shape (FIG. 3) or rounded (FIG. 4).

The teeth are connected in pairs through a bottom 117.1, which is advantageously complementary in shape to the free end of each facing tooth. In the example shown in FIG. 2, the bottom is formed by two concurrent straight-line segments 120.1 and 120.1′ and a point 124.1.

Consequently, the movement distance along the axis of the teeth is limited by the distance d separating the point 122.1, and the point 124.1.

FIG. 5 contains a table showing the variation of d as a function of the angle α at the top of the point 112.1 for an air gap value e=2 μm.

It can be seen that the more acute the angle α, the greater the distance d.

Thus with this invention, it is possible to keep a thin air gap at the end of the tooth, while allowing a large movement distance along the axis of the teeth. In known types of variable capacitors having teeth with a rectangular section, the air gap at the end of the tooth is equal to 2e+w, where e is the air gap between a tooth in the first comb and a tooth in the second comb, and w is the width of a tooth. According to this invention, the air gap at the end of the tooth for teeth with a triangular point is equal to 2e, the thickness of the tooth being zero at the free end of the tooth.

FIG. 3 shows a second example embodiment in which the free ends 212.1, 212.2 of the teeth are trapezoidal in shape, comprising a large base 226.1, 226.2 oriented towards the body of the comb. The bottoms connecting the teeth in pairs are advantageously complementary in shape.

FIG. 4 shows a third example embodiment in which the free ends 312.1, 312.2 of the teeth are also formed by an isosceles triangle, however, the angle at the summit is replaced by the arc of a circle 328.1, 328.2. The bottoms connecting the teeth in pairs are advantageously complementary in shape.

Obviously, a capacitor for which the spaces formed by two teeth are not complementary in shape to the teeth that fit into them does not go outside the scope of this invention.

Obviously, a capacitor for which the combs comprise teeth provided with several points does not go outside the scope of this invention.

Etching is much more uniform because of the shape of the capacitive capacitor according to this invention, due to the uniformity of the dimensions of the air gaps. Furthermore, due to the small size air gaps, it is easier to close off the air gaps during subsequent steps to manufacture interconnections between different parts of the capacitor.

The capacitor according to this invention is particularly advantageous in manufacturing built-in gyrometers made using the micro-technologies for which a large movement distance is very useful.

In the case in which it is required to measure an angular rotation speed with the gyrometer, the mass of the gyrometer is moved by a sine-wave excitation signal. Under the action of the rotation velocity, a Coriolis force is generated about a direction perpendicular both to the excitation signal and to the rotation speed; the output signal is then given by a formula of the following type:

S=2m·Ω·ω_{d}·d

where m represents the mass of all or some of the structure, Ω is the angular input velocity to be measured, ω_{d} represents the angular frequency of the excitation signal, and d is the excitation amplitude.

Therefore, it can be seen that in order to have a high value of the output signal, it is desirable to have a high value of the excitation amplitude. Typically, the objective can be to have displacement amplitude values equal to at least 5 μM, and advantageously equal to 10 μm to obtain gyrometers with good performances. These movement values are possible with the capacitor according to this invention (FIG. 5), for example for an angle α between 40° and 10° or between 30° and 20°.

We will now describe an example of a process for manufacturing a variable capacitor.

Such a process for manufacturing said capacitor comprises:
a step to etch combs in a substrate, the combs having a shape according to this invention,
manufacturing of interconnection means.

A detailed example of the process will be described below.

In a first step, a substrate 402 is made comprising a base 404, for example made of silicon covered on its top face by an insulation layer 406, for example silicon dioxide SiO₂.

In a second step, the layer 406 is etched at zones 408. A layer of SiN is then deposited over the entire surface of the substrate.

The SiN layer is then eliminated by flattening, except in zones 408 forming anchorages.

In a later step, the layer 406 is etched once again at the zones 412 in order to prepare the connection with the substrate.

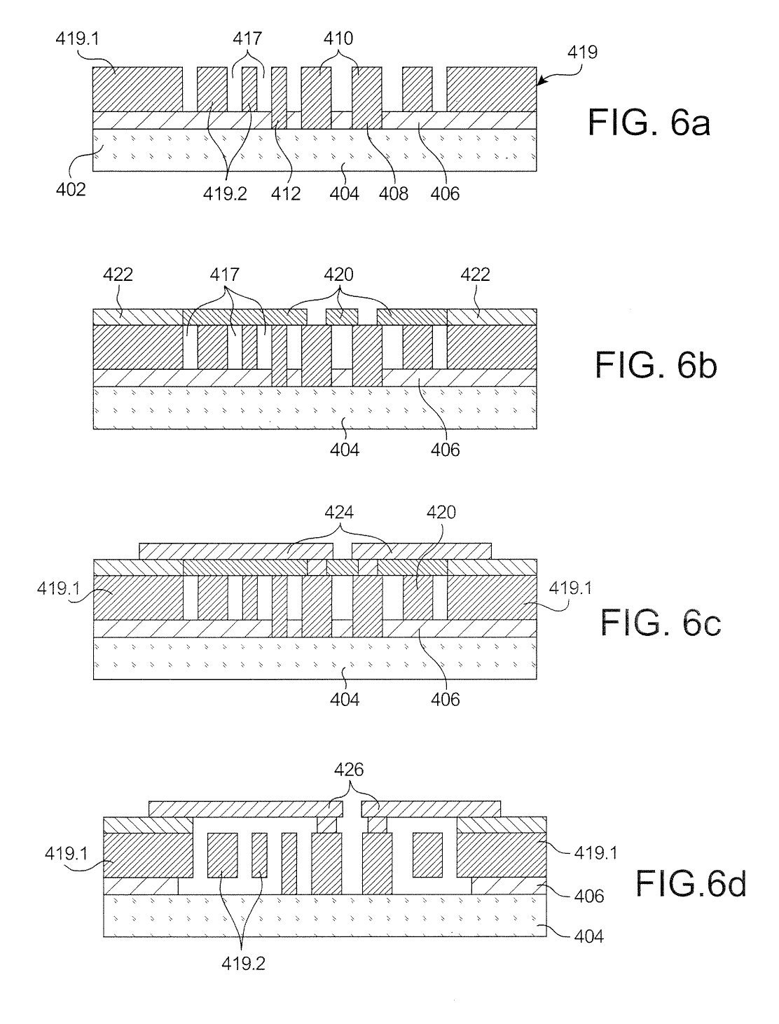

A layer 419 of silicon is then deposited per epitaxy. This layer is then etched so as to form columns 410 and a mobile electrode 419.1 and a fixed electrode 419.2 (FIG. 6a).

In an additional step (FIG. 6b), a PSG (Phosphorus Silicon Glass) type sacrificial layer 420 is deposited for example by PRECVD (Plasma Enhanced Chemical Vapour Deposition) reaction on the top part of the teeth so as to cover the trenches 417. Advantageously, SiN insulation patterns 422 can be produced in advance on the top part of the electrodes by lithography and etching.

The sacrificial layer 420 is then structured to enable an electrical interconnection 426 between the different parts of the capacitor, for example either between the teeth of a particular comb, or a comb and a contact point, or between a column connected to the substrate and a contact point made in an insulation zone 422. In the example shown, passages are etched in the sacrificial layer 420 at the support column 410 and the anchor 408.

In a next step (FIG. 6c), a poly-silicon layer 424 is deposited on the sacrificial layer 420. This layer 424 is then etched so as to form interconnection bridges 426 that can then allow interconnections between different parts of the device as mentioned above.

Finally in a fourth step (FIG. 6d), the sacrificial layer 420 is etched to release the bridges 426. The SiO₂ layer 406 is also etched so as to suspend the mobile electrodes 419.2 from the base 404. The fixed electrode 419.1 remains connected to the base 402 through the SiO₂ layer 406.

In the example shown, the electrodes are made of silicon. However, they could be made of an insulating material, for example quartz covered by a conducting material such as Cr-AU, Al, W-Wn-Au or TiW—Au. The conducting layer is deposited, for example by sputtering or vapour deposition, after the teeth are etched in the insulating material (FIG. 6a). The conducting zones to be preserved are then defined, for example by etching after deposition of a lithography mask. It would also be possible to deposit the conducting material only on appropriate zones through a mechanical mask.

This invention is particularly applicable to gyrometers and accelerometers used in microtechnology, particularly in the automobile industry.

1-19. (canceled)

20: A variable capacitor comprising:
at least a first and a second interdigitized electrode, formed by combs, the combs including a body along a main axis and teeth along secondary axes respectively, the teeth being parallel to each other and configured for a movement along their secondary axis,
the teeth of each comb comprising first ends through which the teeth are connected to the body and free second ends opposite to the first ends facing the other comb, the teeth comprising a first part oriented to the first end with an approximately constant cross section, and the second free end of the teeth having a cross section smaller than the cross section of the first part connected to the comb, the cross section of the second end reducing progressively as the distance from the first end increases, pairs of teeth defining spaces with a shape complementary to the shape of the teeth in the other comb.

21: A capacitor according to claim 20, in which the free ends of the teeth are formed by at least two segments.

22: A capacitor according to claim 21, in which the free ends of the teeth are shaped in a point.

23: A capacitor according to claim 21, in which the free ends of the teeth are shaped as a trapezium, the large base of the trapezium being oriented to the tooth.

24: A capacitor according to claim 21, in which the free ends of the teeth are formed by non-intersecting first and second segments with identical lengths and symmetrical about a longitudinal axis of the tooth and being connected by an infinite number of segments forming an arc of a circle.

25: A capacitor according to claim 20, in which an air gap separating a lateral end of a tooth of a comb from a lateral end of a directly adjacent tooth of another comb is between 1 μm and 3 μm.

26: A capacitor according to claim 20, in which a distance separating the free end of a tooth of a comb from the other comb along an axial direction of the tooth is between 3 μm and 15 μm.

27: A capacitor according to claim 20, in which the combs are made of silicon.

28: A capacitor according to claim 20, in which the combs are made of an electrically insulating material covered with an electrically conducting material.

29: A capacitor according to claim 28, in which the combs are made of quartz or silica.

30: A gyrometer comprising:
a variable capacitor comprising at least a first and a second interdigitized electrode, formed by combs, the combs including a body along a main axis and teeth along secondary axes respectively, the teeth being parallel to each other and configured for a movement along their secondary axis,
the teeth of each comb comprising first ends through which the teeth are connected to the body and free second ends opposite to the first ends facing the other comb, the teeth comprising a first part oriented to the first end with an approximately constant cross section, and the second free end of the teeth having a cross section smaller than the cross section of the first part connected to the comb, the cross section of the second end reducing progressively as the distance from the first end increases, pairs of teeth defining spaces with a shape complementary to the shape of the teeth in the other comb.

31: An accelerometer comprising:
a variable capacitor comprising at least a first and a second interdigitized electrode, formed by combs, the combs including a body along a main axis and teeth along secondary axes respectively, the teeth being parallel to each other and configured for a movement along their secondary axis,
the teeth of each comb comprising first ends through which they are connected to the body and free second ends opposite to the first ends facing the other comb, the teeth comprising a first part oriented to the first end with an approximately constant cross section, and the second free end of the teeth having a cross section smaller than the cross section of the first part connected to the comb, the cross section of the second end reducing progressively as the distance from the first end increases, pairs of teeth defining spaces with a shape complementary to the shape of the teeth in the other comb.

32: A process of manufacturing a variable capacitor variable capacitor including at least a first and a second interdigitized electrode, formed by combs, the combs including a body along a main axis and teeth along secondary axes respectively, the teeth being parallel to each other and configured for a movement along their secondary axis, the teeth of each comb comprising first ends through which they are connected to the body and free second ends opposite to the first ends facing the other comb, the teeth comprising a first part oriented to the first end with an approximately constant cross section and the second free end of the teeth having a cross section smaller than the cross section of the first part connected to the comb, the cross section of the second end reducing progressively as the distance from the first end increases, pairs of teeth defining spaces with a shape complementary to the shape of the teeth in the other comb, comprising a mobile electrode and a fixed electrode, using a substrate, the process comprising:
etching the substrate to form electrode teeth, the teeth being separated by trenches, the teeth having a variable cross section; and
forming electrode connection means.

33: A process according to claim 32, in which forming the electrode connection means comprises:
depositing and structuring a sacrificial layer;
making interconnections on the sacrificial layer between the electrodes and zones to be electrically connected; and
etching the substrate and the sacrificial layer so as to release a mobile electrode.

34: A process according to claim 33, in which SiN insulation patterns are made before the sacrificial layer is deposited.

35: A process according to claim 33, in which the sacrificial layer is made of PSG.

36: A process according to claim 33, in which the interconnections are made of poly-silicon.

37: A process according to claim 33, in which the mobile electrode is released from the substrate by etching the silicon oxide layer.

38: A process according to claim 32, in which the substrate comprises a silicon-base layer covered on one face by a silicon oxide layer, itself covered by a silicon layer.
